(19) United States
(12) Patent Application Publication
(10) Pub. No.: US 2013/0208209 A1
(43) Pub. Date: Aug. 15, 2013

(54) Liquid Crystal Display Module

(71) Applicant: GeGe Zhou, Shenzhen (CN)

(72) Inventor: GeGe Zhou, Shenzhen (CN)

(73) Assignee: Shenzhen China Star Optoelectronics Technology Co. LTD., Shenzhen City, Guangdong (CN)

(21) Appl. No.: 13/508,718

(22) PCT Filed: Mar. 21, 2012
(86) PCT No.: PCT/CN12/72666

§ 371 Date: May 8, 2012

(30) Foreign Application Priority Data
Feb. 15, 2012 (CN) 201210033991.4

(51) Int. Cl. G02F 1/1333

(52) U.S. Cl. 349/58

(57) ABSTRACT

The present invention provides a liquid crystal display module, which includes: a backlight module, a liquid crystal display panel arranged atop the backlight module, and a front bezel arranged on the liquid crystal display panel. The backlight module includes an intermediate frame made of an elastic material. The liquid crystal display panel is mounted on the intermediate frame. The present invention provides an intermediate frame that is made of an elastic material to provide improved cushioning and to ensure tight fitting between the liquid crystal display panel and the intermediate frame so that when the liquid crystal display panel is heated and gets expanding, the intermediate frame undergoes elastic deformation following the expansion and does not compress the liquid crystal display panel.

### BACKGROUND OF THE INVENTION

1. Field of the Invention

The present invention relates to a liquid crystal display module, and in particular to a liquid crystal display module having an intermediate frame made of rubber materials.

2. The Related Arts

Liquid crystal display (LCD) has a variety of advantages, such as compact device size, low power consumption, and being free of radiation, and is thus widely used. Most of the LCDs that are currently available in the market are backlighting LCDs, which comprise a liquid crystal panel and a backlight module. The working principle of the liquid crystal panel is that liquid crystal molecules interposed between two parallel glass plates and a plurality of vertical and horizontal fine electrical wires is arranged between the two glass plates, whereby the liquid crystal molecules are controlled to change direction by application of electricity to refract light emitting from the backlight module for generating images. Since the liquid crystal panel itself does not emit light, light must be provided by the backlight module in order to generate images. Thus, the backlight module is one of the key components of an LCD. The backlight module can be classified as two types, namely side-edge backlight module and direct backlight module, according to the position where light gets incident. The direct backlight module arranges a light source, such as a cold cathode fluorescent lamp (CCFL) or a light-emitting diode (LED) at the back side of the liquid crystal panel to form a planar light source to directly provide lighting to the liquid crystal panel. The side-edge backlight module arranged an LED light bar at an edge of a backboard that is located rearward of one side of the liquid crystal panel. The LED light bar emits light that enters a light guide plate through a light incident face of the light guide plate and is projected out through a light exit face after being reflected and diffused to thereby form a planar light source to be provided to the liquid crystal panel.

The conventional backlight module comprises an intermediate frame for supporting the liquid crystal display panel and blocking light leakage. The intermediate frame is often made of plastic materials. The plastic materials are of relatively poor elasticity and can provide only poor cushioning when acted upon by an external force. It is found that a liquid crystal display panel placed in contact with a plastic-made intermediate frame is easily broken when subjected to an impact in a reliability test. In addition, the mold for injection molding of the plastic-made intermediate frame has an extended manufacturing cycle and high expense, making the development expenditure very high.

### SUMMARY OF THE INVENTION

An object of the present invention is to provide a liquid crystal display module, which comprises an intermediate frame made of an elastic material to provide improved cushioning capability, whereby a liquid crystal display panel positioned in such an intermediate frame shows improved capability of resisting external impact and thus enhances overall quality of the liquid crystal display module and also, the intermediate frame has a short manufacturing cycle and low cost and thus lowers down the manufacturing cost of the whole liquid crystal display module.

To achieve the objective, the present invention provides a liquid crystal display module, which comprises: a backlight module, a liquid crystal display panel arranged atop the backlight module, and a front bezel arranged on the liquid crystal display panel. The backlight module comprises an intermediate frame and the intermediate frame is made of an elastic material. The liquid crystal display panel is arranged on the intermediate frame.

The intermediate frame forms an accommodation section and the liquid crystal display panel is accommodated in the accommodation section.

The backlight module comprises a backboard, a reflection plate positioned inside the backboard, a light guide board arranged on the reflection plate, an optic film arranged on the light guide board, and a backlight source arranged inside the backboard.

The backboard comprises a bottom plate and a side plate perpendicularly connected to the bottom plate. The side plate and the bottom plate jointly define an accommodation space. The reflection plate, the light guide board, the backlight module, and the optic film are accommodated in the accommodation space.

The reflection plate is positioned on the bottom plate of the backboard.

The backlight source is mounted to the side plate of the backboard.

The backlight source comprises a linear LED light bar, which is mounted to the side plate of the backboard through bonding with thermally-conductive adhesive tapes or fixing by bolts.

The elastic material comprises rubber material.

The efficacy of the present invention is that the present invention provides a liquid crystal display module comprising an intermediate frame that is made of an elastic material to provide improved cushioning and to ensure tight fitting between the liquid crystal display panel and the intermediate frame in an assembling operation so that when the liquid crystal display panel is heated and gets expanding, the intermediate frame undergoes elastic deformation following the expansion and does not compress the liquid crystal display panel. After the external environment restores normal, the liquid crystal display panel may resumes the normal size thereof and the elastic deformation of the intermediate frame recovers but still maintain tight engagement with the liquid crystal display panel. The problem of the conventional technique that a plastic intermediate frame cannot restores the original shape and thus makes the liquid crystal display panel wobbling, leading to damage and breaking. Further, such an intermediate frame, as compared to the plastic intermediate frame made through injection molding, has a short manufacturing cycle and low cost.

For better understanding of the features and technical contents of the present invention, reference will be made to the following detailed description of the present invention and the attached drawings. However, the drawings are provided for the purposes of reference and illustration and are not intended to impose undue limitations to the present invention.

### BRIEF DESCRIPTION OF THE DRAWINGS

The technical solution, as well as beneficial advantages, will be apparent from the following detailed description of an embodiment of the present invention, with reference to the attached drawings. In the drawings:

FIG. 1 is an exploded view showing a liquid crystal display module according to the present invention; and

FIG. 2 is a cross-sectional view showing the liquid crystal display module according to the present invention.

### DETAILED DESCRIPTION OF THE PREFERRED EMBODIMENT

To further expound the technical solution adopted in the present invention and the advantages thereof, a detailed description is given to a preferred embodiment of the present invention and the attached drawings.

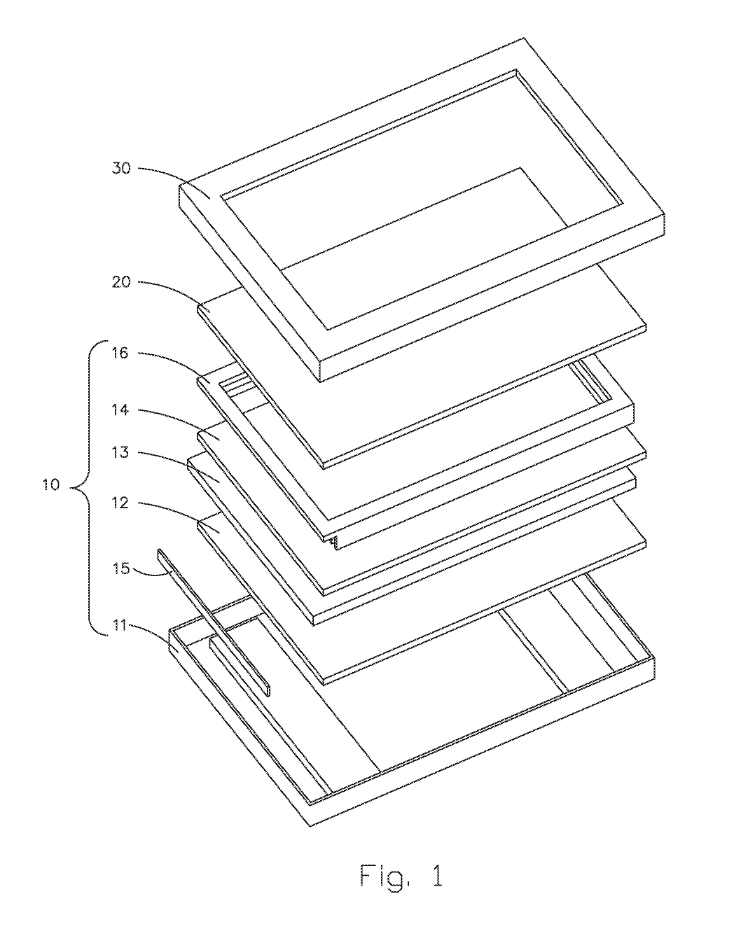

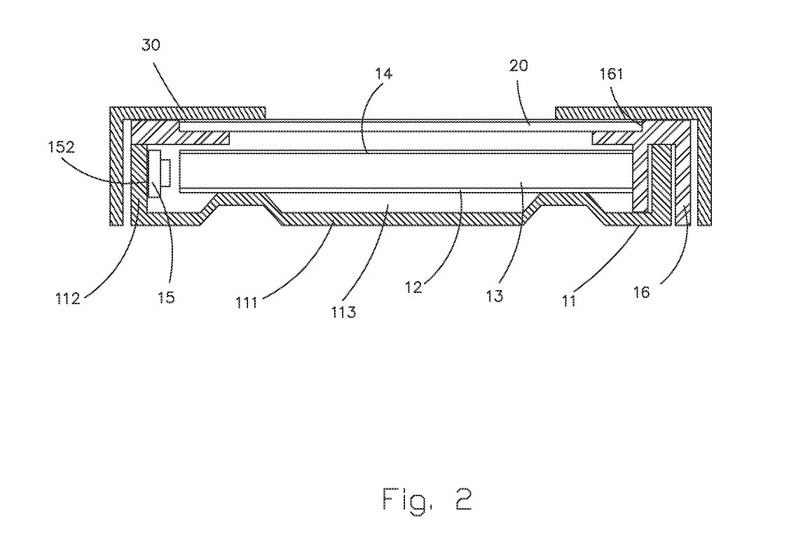

Referring to FIGS. 1 and 2, the present invention provides a liquid crystal display module, which comprises: a backlight module 10, a liquid crystal display panel 20 arranged atop the backlight module 10, and a front bezel 30 arranged on the liquid crystal display panel 20.

The backlight module 10 comprises a backboard 11, a reflection plate 12 positioned inside the backboard 11, a light guide board 13 arranged on the reflection plate 12, an optic film 14 arranged on the light guide board 13, a backlight source 15 arranged inside the backboard 11, and an intermediate frame 16 mounted to the backboard 11.

The backboard 11 comprises a bottom plate 111 and a side plate 112 perpendicularly connected to the bottom plate 111. The side plate 112 and the bottom plate 111 jointly define an accommodation space 113. The reflection plate 12, the light guide board 13, the optic film 14, and the backlight source 15 are accommodated in the accommodation space 113. The reflection plate 12 is positioned on the bottom plate 111 of the backboard 11.

The backlight source 15 comprises a linear LED (Light-Emitting Diode) light source and is mounted to the side plate 112 of the backboard 11 through bonding with thermally-conductive adhesive tapes or fixing by bolts. The backlight source 15 emits light that is transmitted, either directly or after being reflected by the reflection plate 12, into the light guide board 13 and then optic film 14 to thereby provide a planar light source with uniform luminance to the liquid crystal display panel 20.

The intermediate frame 16 is made of an elastic material. In the instant embodiment, the elastic material used is a rubber material. The intermediate frame 16 forms an accommodation section 161 and the liquid crystal display panel 20 is accommodated in the accommodation section 161.

Since the intermediate frame 16 of the backlight module 10 is made of an elastic material that has excellent elasticity to provide excellent cushioning against an impact acting on the liquid crystal display panel 20 that is positioned on the intermediate frame 16 thereby protecting the liquid crystal display panel 20 from being easy damaged and broken to improve overall quality of the liquid crystal module.

Further, when the liquid crystal display panel 20 expands due to being heated, the intermediate frame 16 undergoes elastic deformation to follow the expansion and thus does not apply an excessive pressure to the liquid crystal display panel 20 and eliminating the problem of the conventional technique that the liquid crystal panel deforms due to excessive pressure exerted to the liquid crystal display panel by a plastic intermediate frame. When the liquid crystal display panel 20 contracts due to being cooled, the intermediate frame 16 undergoes elastic deformation to follow the contraction to maintain tight engagement with the liquid crystal display panel 20 in order to eliminate the problem of the conventional technique that the plastic intermediate frame cannot be kept in tight contact with the liquid crystal display panel, making the liquid crystal display panel wobbling and easily breaking, and thus improve the overall quality of the liquid crystal display module.

The liquid crystal display module of the instant embodiment comprises a backlight module 10 that is a side-edge backlight module. In other embodiments, the present invention is equally applicable to direct backlight module, meaning the direct backlight module comprises an intermediate frame made of an elastic material.

In summary, the present invention provides a liquid crystal display module comprising an intermediate frame that is made of an elastic material to provide improved cushioning and to ensure tight fitting between the liquid crystal display panel and the intermediate frame in an assembling operation so that when the liquid crystal display panel is heated and gets expanding, the intermediate frame undergoes elastic deformation following the expansion and does not compress the liquid crystal display panel. After the external environment restores normal, the liquid crystal display panel may resumes the normal size thereof and the elastic deformation of the intermediate frame recovers but still maintain tight engagement with the liquid crystal display panel. The problem of the conventional technique that a plastic intermediate frame cannot restores the original shape and thus makes the liquid crystal display panel wobbling, leading to damage and breaking. Further, such an intermediate frame, as compared to the plastic intermediate frame made through injection molding, has a short manufacturing cycle and low cost.

Based on the description given above, those having ordinary skills of the art may easily contemplate various changes and modifications of the technical solution and technical ideas of the present invention and all these changes and modifications are considered within the protection scope of right for the present invention.

What is claimed is:

1. A liquid crystal display module, comprising: a backlight module, a liquid crystal display panel arranged atop the backlight module, and a front bezel arranged on the liquid crystal display panel, the backlight module comprising an intermediate frame, the intermediate frame being made of an elastic material, the liquid crystal display panel being arranged on the intermediate frame.

2. The liquid crystal display module as claimed in claim 1, wherein the intermediate frame forms an accommodation section and the liquid crystal display panel is accommodated in the accommodation section.

3. The liquid crystal display module as claimed in claim 1, wherein the backlight module comprises a backboard, a reflection plate positioned inside the backboard, a light guide board arranged on the reflection plate, an optic film arranged on the light guide board, and a backlight source arranged inside the backboard.

4. The liquid crystal display module as claimed in claim 3, wherein the backboard comprises a bottom plate and a side plate perpendicularly connected to the bottom plate, the side plate and the bottom plate jointly defining an accommodation space, the reflection plate, the light guide board, the backlight module, and the optic film being accommodated in the accommodation space.

5. The liquid crystal display module as claimed in claim 4, wherein the reflection plate is positioned on the bottom plate of the backboard.

6. The liquid crystal display module as claimed in claim 4, wherein the backlight source is mounted to the side plate of the backboard.

7. The liquid crystal display module as claimed in claim 6, wherein the backlight source comprises a linear LED light bar, which is mounted to the side plate of the backboard through bonding with thermally-conductive adhesive tapes or fixing by bolts.

8. The liquid crystal display module as claimed in claim 1, wherein the elastic material comprises rubber material.
